(19) United States
(12) Patent Application Publication
(10) Pub. No.: US 2022/0148391 A1
(43) Pub. Date: May 12, 2022

(54) CONCEALABLE VISUAL INDICATOR

(71) Applicant: Tucker Maidstone LLC, Westport, CT (US)

(72) Inventor: Adam Yormark, Westport, CT (US)

(21) Appl. No.: 17/524,396

(22) Filed: Nov. 11, 2021

Related U.S. Application Data
(60) Provisional application No. 63/112,387, filed on Nov. 11, 2020.

(51) Int. Cl. G08B 5/02

(52) U.S. Cl. CPC G08B 5/02

(57) ABSTRACT

An indicator assembly includes an indicator, a housing configured to receive the indicator in a lowered position of the indicator and to enable the indicator to extend from the housing in a raised position of the indicator, a hinge mechanism configured to enable the indicator to rotate relative to the housing between the lowered position and the raised position, and a switch mechanism includes a switch assembly coupled to the indicator and the housing. The switch assembly is configured to move back and forth along a slider track of the housing such that the indicator moves from the lowered position to the raised position to thereby indicate a status of a user of the indicator assembly.

### CROSS-REFERENCE TO RELATED APPLICATION(S)

This application claims priority to U.S. provisional application 63/112,387 filed on Nov. 11, 2020 and entitled Concealable Visual Indicator, which is herein incorporated by reference in its entirety.

### FIELD OF TECHNOLOGY

Indicator assemblies provide a visual indicator of when a user is busy and are configured with an indicator that can be raised and lowered into a housing of the indicator assembly.

### BACKGROUND

Modern life, especially working life, is increasingly spent on the computer. A person appears identical when they are performing an important activity (such as a teleconference call or video call) as when they are otherwise doing unimportant work (often with headphones). Onlookers or visitors may not know the person is busy and may result in interruptions.

### SUMMARY

Implementations provide an unobtrusive visual indicator to convey that an important event (such as a teleconference, meeting, or video chat, important work, etc.) is currently ongoing. The indicator may be attached in a convenient location (such as a doorframe, a door, the back of a computer or tablet, or any other location in which the invention would be useful) so that it may be readily available and easily used. It may in some embodiments be integrated into the frame or case of a host device or product.

According to certain implementations, an indicator assembly includes an indicator, a housing configured to receive the indicator in a lowered position of the indicator and configured to enable the indicator to extend from the housing in a raised position of the indicator, a hinge mechanism configured to enable the indicator to rotate relative to the housing between the lowered position and the raised position, and a switch mechanism includes a switch assembly coupled to the indicator and the housing. The switch assembly is configured to move back and forth along a slider track of the housing such that the indicator moves, e.g., rotates, from the lowered position to the raised position to thereby indicate a status of a user of the indicator assembly.

In various implementations and alternatives, the indicator includes a first positioning aid, and the housing includes a second positioning aid and a third positioning aid. An arrangement of the first positioning aid relative to the second positioning aid defines a raised position in which the first positioning aid and the second positioning aid cooperate or facilitate maintaining the indicator in the raised position, and an arrangement of the first positioning aid relative to the third positioning aid defines a lowered position in which the first positioning aid and the third positioning aid cooperate or facilitate maintaining the indicator in the lowered position. In such implementations and alternatives, the second positioning aid and the third positioning aid are arranged angularly offset relative one to another. The angular offset may be about 70 to about 110 degrees. The hinge mechanism may be defined by the indicator and the housing, and the positioning aids may be arranged proximate the hinge mechanism. In such implementations, the indicator is configured as an arm and includes an indicator shaft coupling the indicator head to an indicator base, where the indicator base defines a portion of the hinge mechanism.

In additional implementations and alternatives, the first positioning aid is configured as a magnet and the second positioning aid and the third positioning aid are configured as a magnet or a ferromagnetic material. Alternatively, the first positioning aid is configured as a ferromagnetic material, and the second positioning aid and the third positioning aid are configured as magnets angularly offset relative to one another. The angular offset may be about 70 to about 110 degrees. The switch assembly may be configured to pivot the indicator between the lowered and raised position upon overcoming a force between the first positioning aid and either of the second positioning aid or the third positioning aid.

The indicator head may be configured to be exposed from the housing in the raised position of the indicator and may include at least one of a rounded head or a sloped edge. The indicator assembly may be configured to couple to an object by an attachment feature. In addition or alternatively, the indicator assembly is configured to be integrated into an object such that the housing of the indicator assembly is defined by the object, and may be a computer device.

In implementations and alternatives, the indicator includes a first positioning aid configured as a magnet or ferromagnetic material, and the housing includes a second positioning aid and a third positioning aid configured as the other of the magnet or ferromagnetic material. An arrangement of the first positioning aid relative to the second positioning aid defines a raised position in which the magnet and ferromagnetic material are attracted to each other, and an arrangement of the first positioning aid relative to the third positioning aid defines a lowered position in which the first positioning aid and the third positioning aid are attracted to each other. In such implementations and alternatives, the second positioning aid and the third positioning aid are arranged angularly offset relative to one another, such as about 70 to about 110 degrees.

In further implementations and alternatives, the indicator includes a first positioning aid configured as a magnet, and the housing includes a second and a third positioning aid configured as magnets, an arrangement of the first positioning aid relative to the second positioning aid defines a raised position in which the magnet of the first positioning aid and the magnet of the second positioning aid repel or attract each other, and an arrangement of the first positioning aid relative to the third positioning aid defines a lowered position in which the first positioning aid and the third positioning aid repel or attract each other. In such implementations and alternatives, the second positioning aid and the third positioning aid are arranged angularly offset relative to one another, such as about 70 to about 110 degrees.

### BRIEF DESCRIPTION OF THE DRAWINGS

FIGS. 1A-1F illustrate back isometric, back, side, front, top, and front isometric views, respectively of an indicator assembly with the indicator in a raised position, according to implementations of the present disclosure;

FIGS. 2A-2E illustrate back isometric, top, back, left side, and front views, respectively, the indicator assembly with the indicator in a concealed position within a housing of the indicator assembly, according to implementations of the present disclosure;

FIG. 3 illustrates an exploded view of the indicator assembly, according to implementations of the present disclosure;

FIG. 4 illustrates an exploded view of the indicator assembly that includes an arrangement of indicator positioning aids, according to implementations of the present disclosure;

FIGS. 5A-5D illustrate a detailed view of the arrangement of positioning aids of the indicator assembly of FIG. 4, according to implementations of the present disclosure;

FIGS. 6A-6D illustrate an isometric view, top view, side view, and front view of the indicator of the indicator assembly, respectively, according to implementations of the present disclosure;

FIGS. 7A-7E illustrate the housing of the indicator assembly in an isometric view, top view, side view, a front view, and an isometric view with adhesive, respectively, according to implementations of the present disclosure;

FIGS. 8A-8D illustrate a switch knob and slider pin assembly of a switch mechanism of the indicator assembly, according to implementations of the present disclosure;

FIGS. 8E-8H illustrate an integrally formed switch knob and slider pin of the switch mechanism of the indicator assembly, according to implementations of the present disclosure;

FIGS. 9A-9D illustrate the switch knob of the switch knob and slider pin assembly, according to implementations of the present disclosure;

FIGS. 10A-10D illustrate the slider pin of the switch knob and slider pin assembly, according to implementations of the present disclosure;

FIG. 11 illustrates a back plate of the indicator assembly, according to implementations of the present disclosure;

FIGS. 12A-12C illustrate the indicator assembly joined to a user's device, according to implementations of the present disclosure;

FIGS. 13A-13C illustrate the indicator assembly integrated with a user's device, according to implementations of the present disclosure;

FIGS. 14A-14B illustrate the indicator assembly coupled to a door in a recessed and raised position, respectively, according to implementations of the present disclosure; and

FIGS. 15A-15C illustrate another indicator assembly that includes a compression spring, according to implementations of the present disclosure.

FIGS. 16A-16C illustrate another indicator assembly, according to implementations of the present disclosure.

### DETAILED DESCRIPTION

Indicator assemblies comprised of an indicator, casing, and switch mechanism are disclosed. The indicator assemblies may be used to visually signify the undergoing of a process or event including, but not limited to, a room being occupied, a meeting, phone call, video call, filming, other events in-process, or other processes, events, or circumstances in which a visual indicator may be useful. The visual indicator may have a variety of configurations to visually indicate to an onlooker that the user is occupied. The indicator may be hidden within a housing or casing of the indicator assembly, and by use of a switch mechanism, the indicator may extend from the housing or casing so as to be visible. When not in use, the indicator may be retracted into the housing or casing such that the indicator is unobtrusive, concealed, or hidden. The indicator assemblies may be attached to an object or surface by means of glue, adhesives, screws, bolts, Velcro, magnets, or other means of attachment. These may also be integrated into the frame of another product or object. Objects that the device might be connected to or integrated with may include, but are not limited to, computer devices such as laptop computers, tablets or headphones, doorframes, walls, appliances, or other objects where it may be useful to convey a message or status.

[symbol]

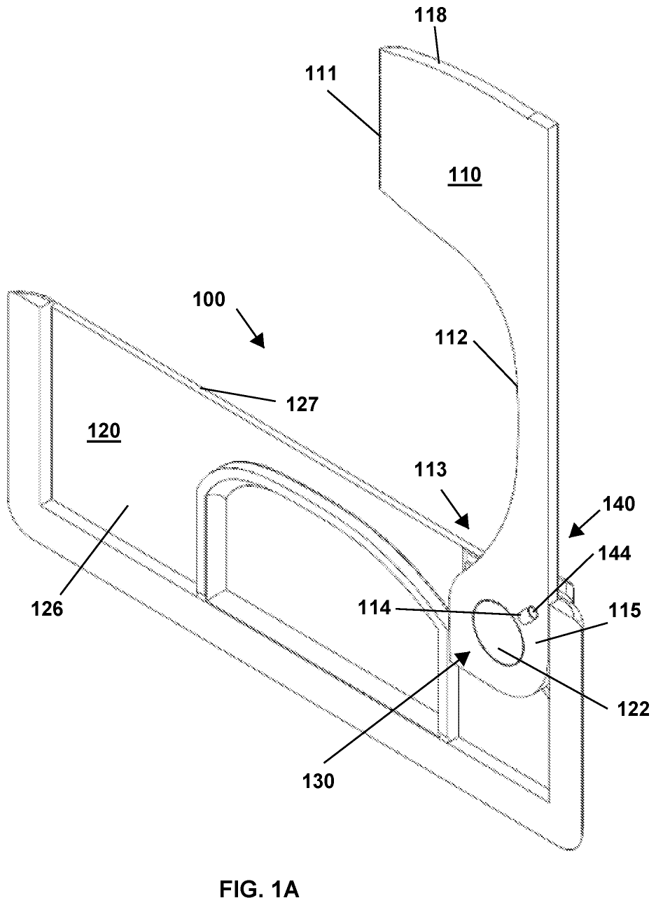

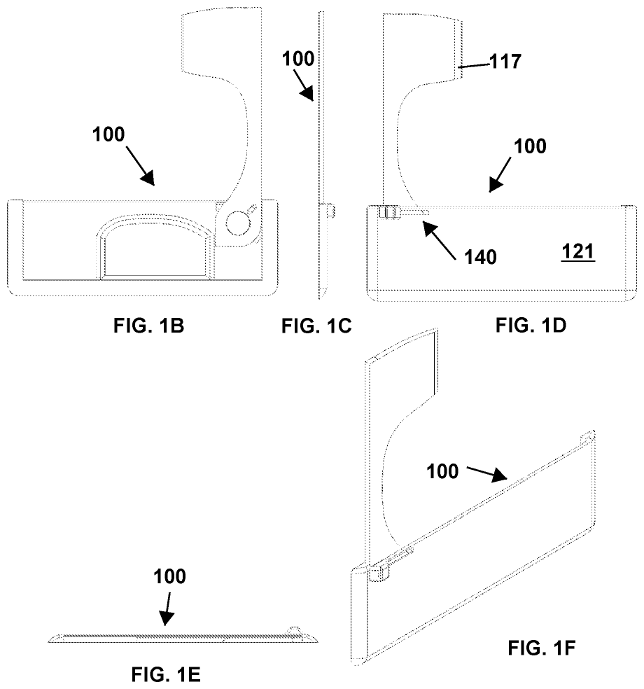

With reference to the figures, FIGS. 1A, 1B, 1C, 1D and 1F illustrate an indicator assembly 100 with an indicator 110, a housing 120, a hinge mechanism 130, and a switch mechanism 140. The indicator assembly 100 is a mechanical device that can be operated by a user, and may not require an electronic power source to operate.

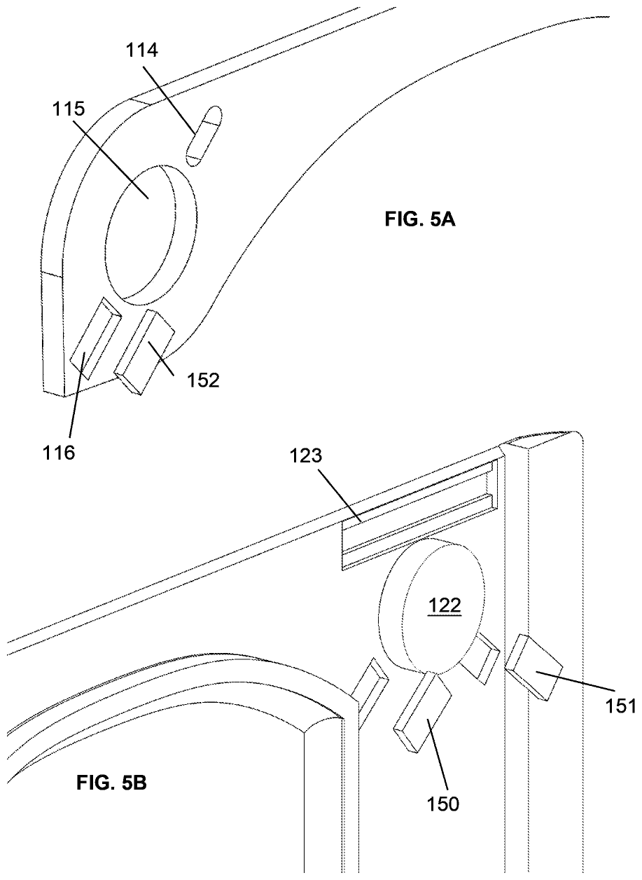

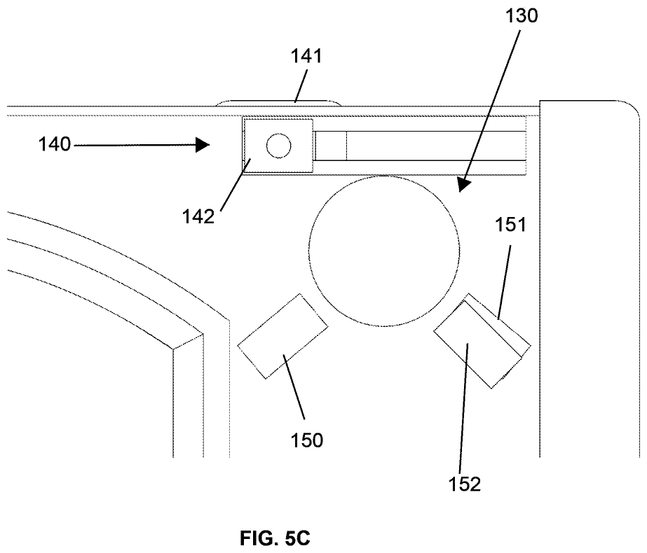

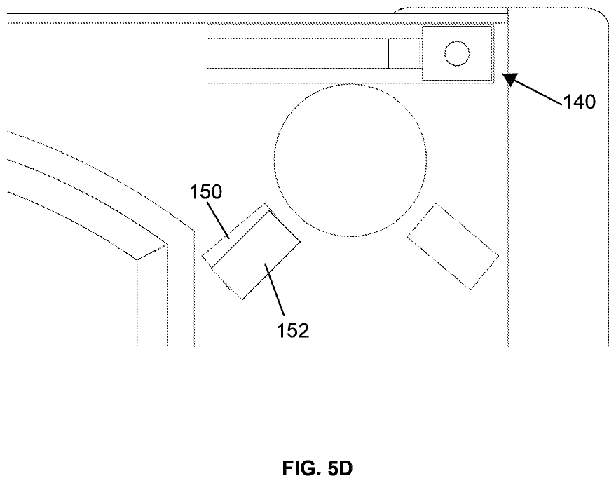

The indicator 110 may be configured to be received by an internal region of the housing 120, and for instance may have a shape complementary to an internal region of the housing 120 to allow for a form fit, and may include components of the hinge mechanism 130 and the switch mechanism 140. The indicator 110 of the indicator assembly 100 includes an indicator head 111, an indicator shaft 112, an indicator base 113, an indicator cam slot 114, a hinge ring 115, and a recess 116 (see FIG. 5A).

The indicator head 111 of the indicator 110 may be configured as a visual indicator that may take a variety of forms and shapes including, but not limited to, a flag, banner, pennant, rectangle, circle, crescent moon, checkmark, X, or other shapes and forms that may be useful in conveying a message. The indicator 110, or a portion thereof, e.g., the indicator head 111, may be any color or may be decorated with a symbol, word, phrase, pattern, or other image. In some implementations, and as illustrated in FIGS. 1A and 1D, the indicator head 111 may be configured with a rounded head 118 and a sloped edge 117 (see FIG. 1D). The rounded head 118 may facilitate moving the indicator 110 into the housing 120 due to the indicator 110 rotating into the housing via the hinge mechanism 130. As the indicator 110 rotates toward the housing, a leading end of the rounded head 118 may provide sufficient clearance between the indicator head 111 and the housing 120 to enable the indicator 110 to rotate fully into and be received by the housing 120. The sloped edge 117 (see FIG. 1D) may facilitate alignment and receipt of the indicator 110 at an opening of the housing 120 to enable the indicator 110 to be received in an interior of the housing 120. For instance, where an opening of the housing 120 is sized to closely receive the indicator 110, e.g., the width of the opening of the housing 120 and the width of the indicator 110 provide a small amount of clearance between each other, a leading edge of the sloped edge 117 of the indicator 110 may have a smaller width relative to an indicator 110 width and may first contact an external frame at the opening of the housing 120 with some additional clearance due to the sloping configuration of the edge 117, and as the indicator 110 is moved further into the housing 120, a width of the sloped edge 117 widens as the edge terminates and transitions into the width of the indicator head 111 and indicator 110 generally.

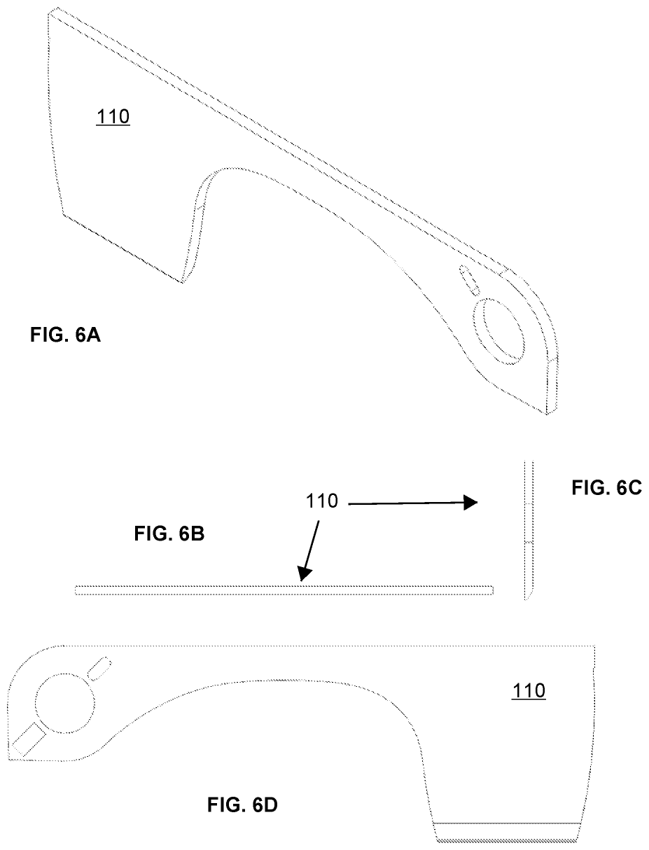

The indicator shaft 112 of the indicator 110 may join the indicator head 111 to the indicator base 113. The indicator base 113 of the indicator 110 may define a cam slot 114, a hinge ring 115, and a recess 116 (see FIG. 5A). The indicator cam slot 114 may be configured to receive a slider cam 144, according to aspects of the disclosure described further herein. The hinge ring 115 may define a component of the hinge mechanism 130 to enable the indicator 110 to rotate relative to the housing 120 of the indicator assembly 100. The recess 116 of the indicator 110 may be configured to receive a component of an indicator positioning aid, such as a magnet, and may have a shame complementary to the positioning aid, such as rectangular, square, circle oval-shaped and so on. FIGS. 6A, 6B, 6C and 6D also illustrate various views of the indicator 110.

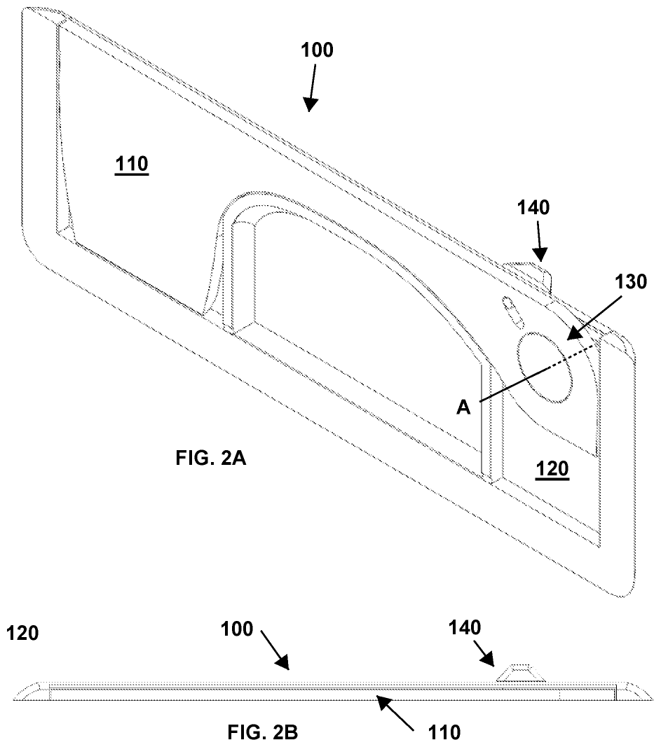

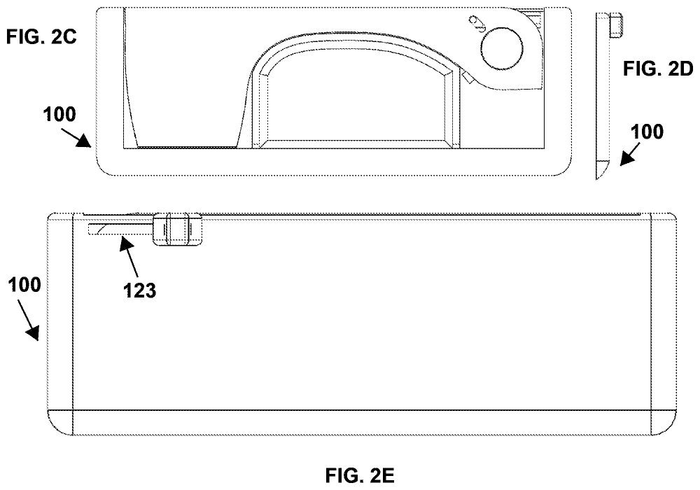

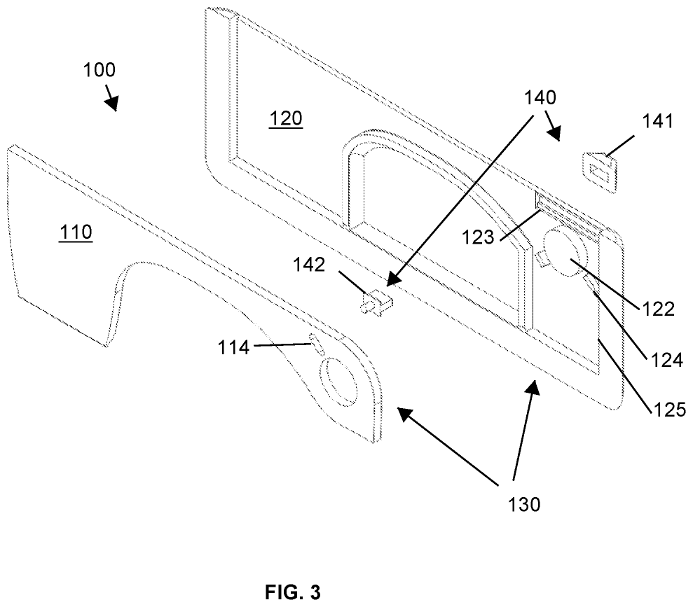

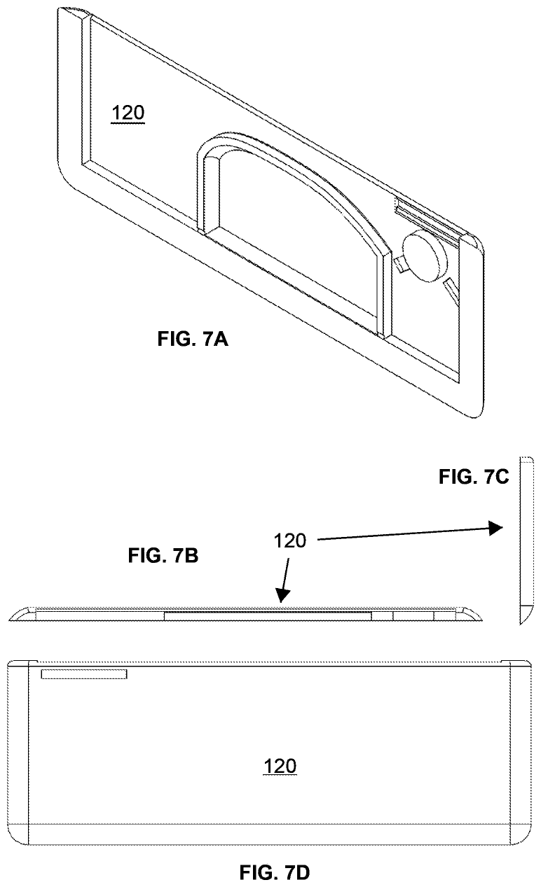

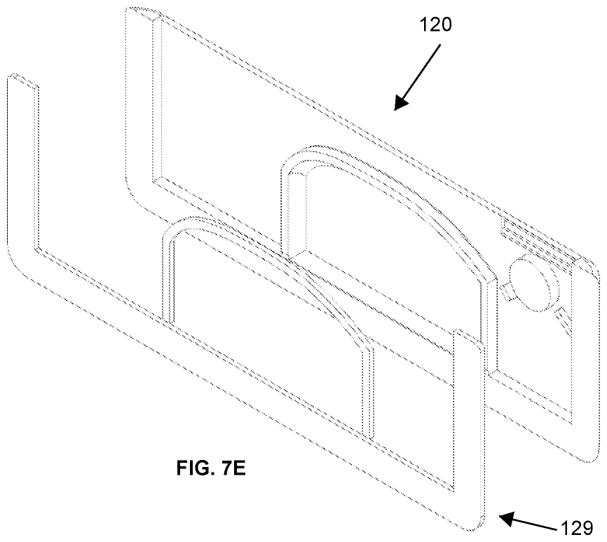

The housing 120 of the indicator assembly 100 may be configured to receive the indicator 110 and may include components of the hinge mechanism 130 and the switch mechanism 140. The housing 120 may include a front plate 121 (FIG. 1D), a hinge shaft 122 (FIG. 3), a slider track 123 (FIG. 2E), a recess 124, an indicator stopping edge 125, a housing interior 126 (e.g., an indicator compartment), and a chamfered compartment edge 127. The front plate 121 may be configured to hide the indicator 110 when the indicator 110 is in the concealed position as illustrated in FIGS. 2A, 2B, 2C, 2D and 2E. The front plate 121 may include an exterior surface and an interior surface. A top edge of the front plate 121 may have a chamfered edge 127 angled downward towards the interior surface to form a ramp or narrowed portion of the front plate 121 in order to facilitate seating the indicator 110 as it rotates into the housing 120. For instance, as the indicator 110 is moved into the housing 120, the chamfered edge 127 of the front plate 121 may cooperate slidingly with the chamfered edge 117 of the indicator 110 to enable a distal end of the indicator 110 to be more easily received at an opening of the interior of the housing via the chamfered edge 127. The hinge shaft 122 may be configured to cooperate with the hinge ring 115 of the indicator 110 in order to provide a rotatable hinge of the hinge mechanism 130. The slider track 123 is configured to receive a pin coupled to a slider to enable the switch mechanism to move from a first position to a second position according to aspects of the disclosure described further herein. The recess 124 is configured to receive a component of an indicator positioning aid, such as a magnet, which may cooperate with the positioning aid of the indicator 110. In addition to magnets, positioning aids may include but are not limited to fasteners, hooks, cams, abutments and so on, configured to cooperate in a raised position on one hand, and a lowered or retracted position on the other hand. The indicator stopping edge 125 may define an edge at an interior of the housing 120 configured to stop the indicator 110 from further rotating within the housing, for instance, to prevent over-rotation of the indicator 110 relative to the housing 120. The indicator interior 126 may define an area for receiving the indicator 110 and may also be referred to as the indicator compartment. The chamfered compartment edge 127 may be configured to receive the indicator 110 or a portion thereof, e.g., the indicator shaft 112, and facilitate guiding the indicator 110 into a seated position within the housing 120 when moving into the concealed position. FIGS. 7A, 7B, 7C, 7D and 7E also illustrate various views of the housing 120 of the indicator assembly 100, with FIG. 7E, illustrating the housing 120 with an adhesive layer 129. The adhesive layer 129 may have various configurations, and for instance, may be configured based on the configuration of an object to which the indicator assembly is to be coupled.

The hinge mechanism 130 of the indicator assembly 100 enables the indicator 110 to rotate relative to the housing 120 from a raised position in which the indicator 110 is exposed from the housing 120 and visible to an onlooker (e.g., FIG. 1A), to a lowered or concealed position in which the indicator 110 is arranged in the housing (e.g., FIG. 2A). Where the housing 120 is opaque, the indicator 110 may be concealed therein. The hinge mechanism includes a hinge ring 115 of the indicator 110 and a hinge shaft 122 of the housing 120. The hinge ring 115 and hinge shaft 122 are configured as a rotatable hinge to enable relative rotation about a central axis “A” (FIG. 2A) arranged perpendicular to a front or facing side of the indicator assembly 100. Although the figures illustrate the indicator 110 as including the hinge ring 115, and the housing 120 including the hinge shaft 122, the hinge mechanism 130 may alternatively include a hinge shaft on the indicator 110 and a hinge ring on the housing 120 of the indicator assembly.

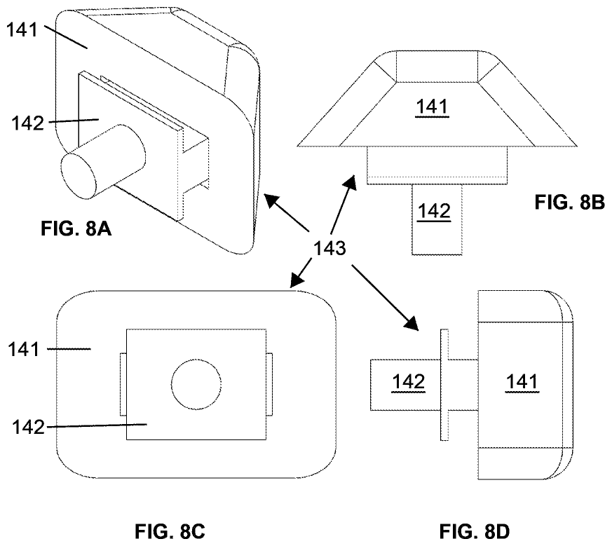

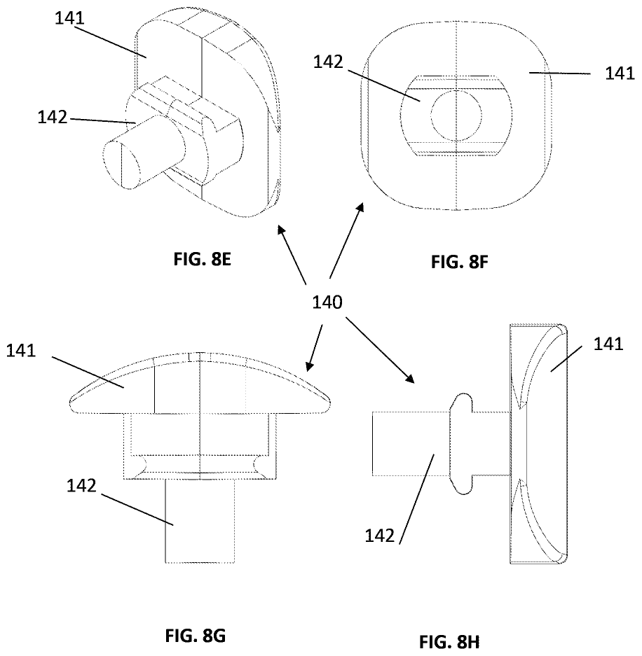

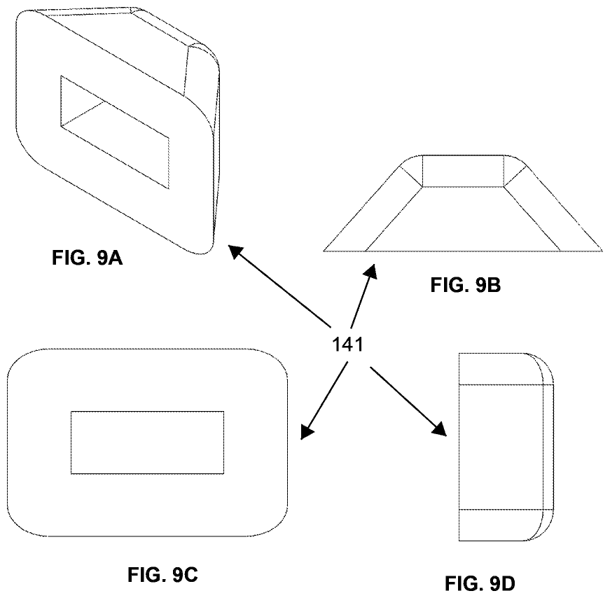

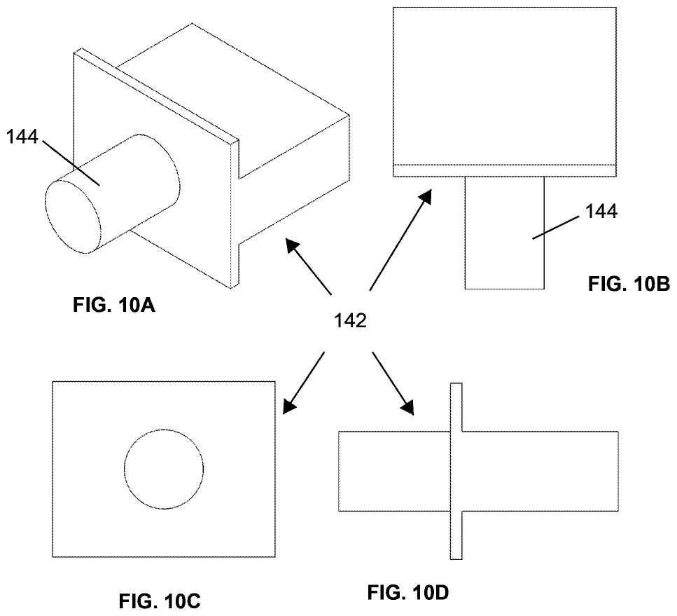

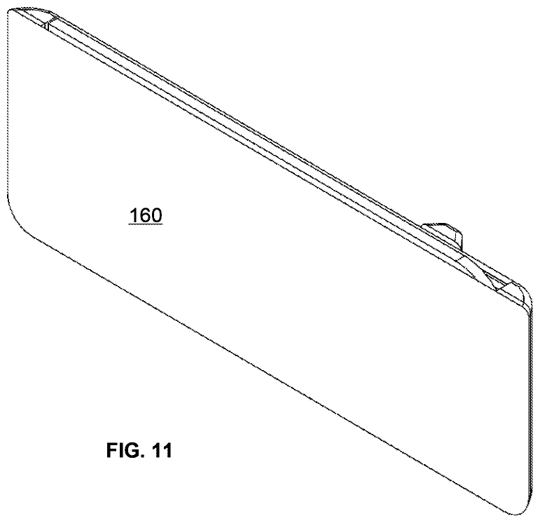

The switch mechanism 140 of the indicator assembly 100 is actuable by a user in order to move the indicator 110 between the raised position (e.g., FIG. 1A) and the lowered position (e.g., FIG. 2A). In a first position of the switch mechanism 140, for example, shown in FIG. 1D, the indicator 110 is in the raised position; and in a second position of the switch mechanism, for example, as shown in FIG. 2E, the indicator is in the lowered position. FIG. 3 illustrates an exploded view of components of the indicator assembly 100 in which the components of the switch mechanism 140 are shown prior to assembly. The switch mechanism 140 includes a switch knob 141 and a slider pin 142 which may be assembled in a switch assembly 143 (FIGS. 8A, 8B, 8C and 8D) or the switch knob 141 and slider pin 142 may be integrally formed (FIGS. 8E-8H). The switch knob 141 is configured to slide between the first and second positions of the switch mechanism 140 along the slider track 123 of the housing 120, e.g., configured as a linear track as illustrated in FIG. 3. The switch knob 141 may include a coupling region configured to couple to a complementary coupling region of the slider pin 142 or may integrally formed with the slider pin 142. As illustrated in FIGS. 9A, 9B, 9C and 9D, the switch knob 141 may include a recess, and as illustrated in FIGS. 10A, 10B, 10C and 10D the slider pin 142 may include a block-shaped cam configured to be coupled to the complementary recess of the switch knob 141. When joining the switch knob 141 to the slider pin 142, the block shaped cam of the slider pin 142 may pass through an internal portion of the housing 120 via the slider track 123 and may be inserted into the recess of the switch knob 141. Alternatively, when the switch mechanism 140 includes integrally formed components, or is in a pre-assembled state, and when joining to the housing 120, the slider pin 142 may pass from the exterior of the housing 120 to the housing interior 126, and the slider pin 142 may snap into place for instance in the slider track 123. A cam portion 144 of the slider pin 142 may be received by a cam slot 114 of the indicator 110, which enables the switch mechanism 140 to move the indicator 110 as the indicator 110 rotates between the raised and lowered positions. The cam slot 114 of the indicator 110 is configured as a track, which guides the indicator 110 in rotation upwards or downwards relative to the housing 120 as the switch assembly 143 moves back and forth, e.g., linearly, along the slider track 123 of the housing 120. As will be appreciated from the Figures, such as by a comparison of FIGS. 1A and 2A, the geometry and placement of the cam slot 114 on the indicator 110, in relation to the geometry and placement of the slider track 123 facilitate transferring the linear movement of the switch assembly 143 into rotational movement of the indicator 110. In alternative configurations, the switch knob 141 and slider pin 142 may be configured as a unitary piece, and the slider track 123 may be configured as a two-piece assembly that can be assembled around the unitary switch/slider, or the slider track 123 may be configured with a unitary construction and have a level of plasticity that enables the slider pin 142 to be assembled therethrough.

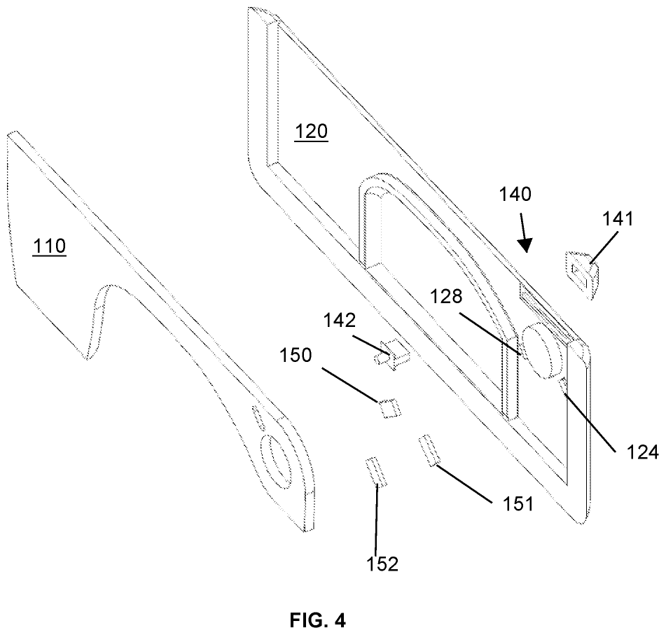

FIG. 4 illustrates an exploded view of the indicator assembly 100 that includes an arrangement of positioning aids 150-152 and recesses 124 and 128 of the housing 120 in which the positioning aids 150 and 151 may be arranged upon assembly of the indicator assembly 100. The positioning aid 152 may be arranged in the recess 116 of the indicator (FIG. 5A) and may be, for instance, configured as a magnet or a ferromagnetic material. Positioning aids 150 and 151 may be arranged at an interior of the housing 120 and coupled thereto in an area proximate the hinge mechanism 130, and may be, for instance, configured as a magnet or a ferromagnetic material. The positioning aids 150 and 151 may be angularly offset from one another, for instance as illustrated in FIG. 5B. The angular offset may be 70 to 180 degrees, for instance about 70 to about 110 degrees. However, other angular offsets may include 60, 75, 85, 95, 100, 120, 130, 140, 150, 160, 170, 190, 200 or 210 degrees. The position of the positioning aid 150 may facilitate retaining the indicator 110 in a raised position (FIG. 1A), which the position of the positioning aid 151 may facilitate retaining the indicator 110 in a lowered position (FIG. 2A). With reference to FIG. 5A, the positioning aid 152 may be arranged in the recess 116 of the indicator 110. When the positioning aid 152 is configured as a magnet, a polarity of the side of the magnet 152 facing positioning aids 150 and 151 configured as magnets of the housing 120 may be different, and thus the magnets may attract each other (e.g., S/N or S/N). Due to the magnet of the positioning aid 152 of the indicator 110 being attracted to either of the opposing positioning aids 150 and 151, the indicator 110 is urged to its lowered position by the attractive force of the magnets 151/152 (FIG. 5C), or urged remain in its open position by the attractive force of the magnets 150/152 (FIG. 5D). In some implementations, the polarity of the opposing magnets may be the same as one another (e.g., N/N or S/S) so that the magnets repel one another in the opened and closed position. In such implementations, the arrangement of the positioning aids 151 and 152 configured as magnets on the housing 120 may be slightly offset with the magnet 152 of the indicator 110 to reach a desired open position and a desired closed position. In further implementations, the polarity of opposing positioning aids configured as magnets (e.g., 150/152) may be opposite one another, while the polarity of opposing positioning aids configured magnets (e.g., 151/152) at a second portion of the housing may be the same as each other, so as to repel the positioning aid 152 of the indicator 110 to one of the positioning aids of the housing 120 (e.g., positioning aid 152) and attract the positioning aid 152 relative to the other positioning aid of the housing 120 (e.g., positioning aid 151). When magnets are employed as positioning aids, a strength of the magnets may be sufficient to retain the indicator 110 in the raised or lowered position, but may be weak enough so that the indicator 110 can be moved between positions upon actuation of the switch mechanism 140. For instance, the strength of the magnets may be about 50 to 200 gauss, or about 100 gauss, which is the strength of a common refrigerator magnet. In some implementations, one or more of the magnets may have differing strengths relative to each other. In further implementations, more than two magnets may be provided on the housing 120, for instance, to define multiple positions of the indicator 110. In yet further implementations, the indicator 110 may include multiple magnets, while the housing 120 may include one magnet, which enables the magnets of the indicator 110 to be influenced by the magnet of the housing 120. The positioning aid 152 or positioning aids 150, 151 may also be replaced by a piece of ferromagnetic material, such as iron, nickel, aluminum or another ferromagnetic metal, while the other of the positioning aids of the housing or the indicator may be formed of a magnetic material or magnet. The magnets may have a variety of shapes including rectangular, square, circular, oval, and so on.

FIG. 11 illustrates a back plate 160 that may optionally be included on the indicator assembly 100. The back plate 160 may define an external surface for coupling the assembly 100 to an object using a mounting feature such as glue, adhesives, screws, bolts, Velcro, magnets, or other means of attachment. In some implementations, the external surface of the back plate 160 may include one or more of such mounting features, and for instance may include an adhesive layer on all or a portion of the external surface. For instance, the back plate 160 may include an adhesive backing such as the adhesive backing 129 illustrated in FIG. 7E, which may be provided in various configurations, and for instance may be configured based on the configuration of an object to which the indicator assembly 100 is to be coupled. As illustrated in FIG. 7E, the adhesive backing 129 may alternatively be joined directly to the housing 120 for joining to an object. Returning to FIG. 11, the back plate 160 may also define an internal surface of the housing 120 interior for receiving the indicator 110 in the concealed position.

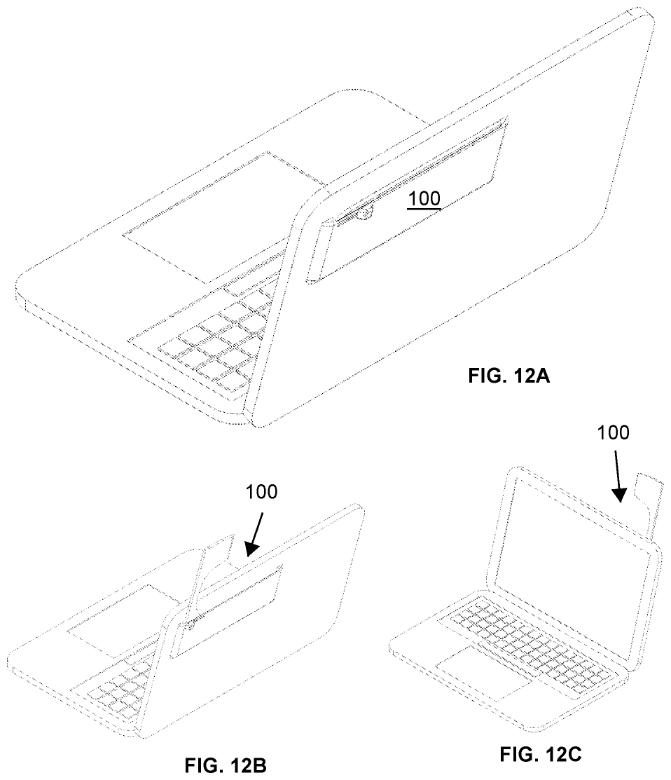

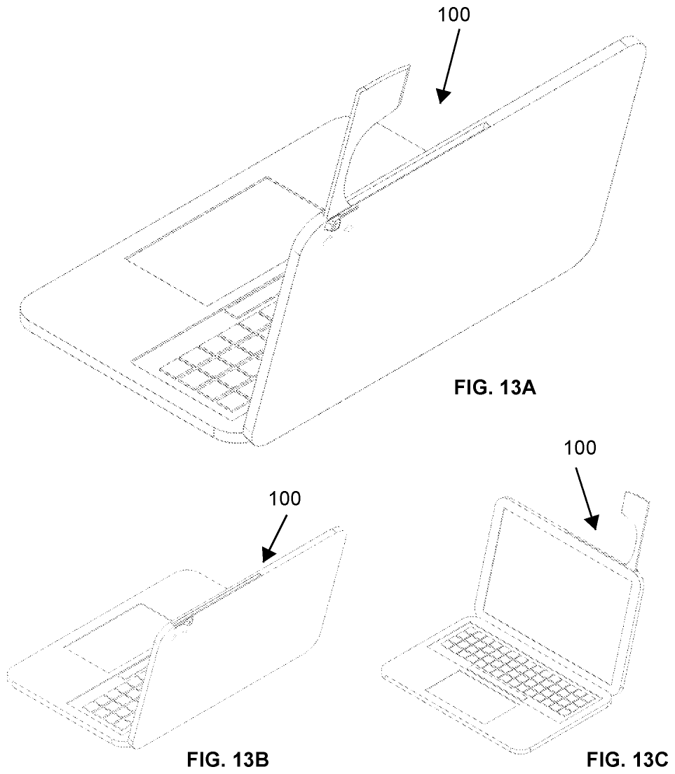

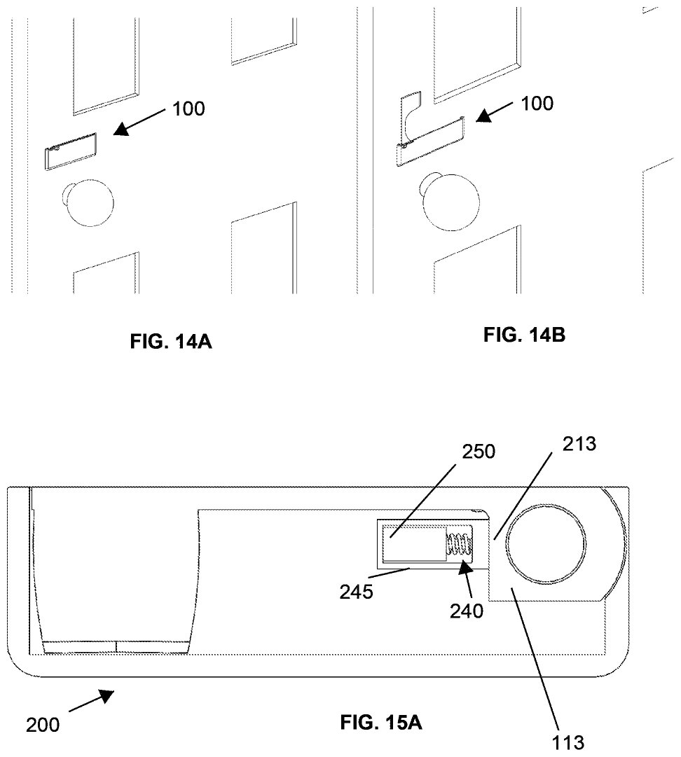

The indicator assembly 100 may be provided on a variety of objects such as laptop computers, doorframes, walls, tablets, headphones, appliances, or other objects where it may be useful to convey a message or status. FIGS. 12A, 12B and 12C illustrate the indicator assembly 100 joined to a user's device, particularly a laptop computer. The indicator assembly 100 may be attached to the objects for instance, through the mounting features disclosed. These may also be integrated into the frame of another product or object. FIGS. 13A, 13B and 13C illustrate the indicator assembly 100 integrated with a user's device, such as a laptop computer. In this embodiment, the housing 120 of the indicator assembly may be integrated with the object, such as integrated into the screen housing of a laptop computer, and may otherwise be mounted on the back of a host device. FIGS. 14A-14B illustrate the indicator assembly 100 coupled to a door in a recessed and raised position, respectively.

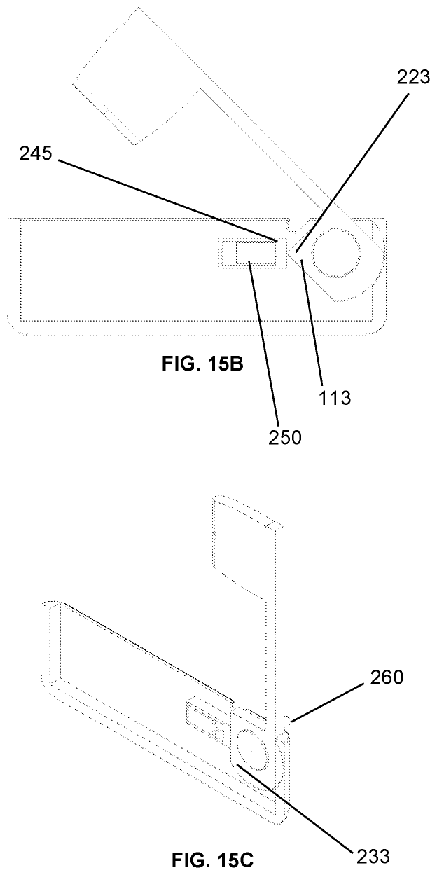

FIGS. 15A-15C illustrate another embodiment of an indicator assembly 200 that includes a compression spring 240. The indicator assembly 200 includes components similar to the indicator assembly 100 and therefore common components are not repeated. The main difference between the indicator assembly 200 and the indicator assembly 100 is that a compression spring 240, a slidable component 245 and a fixed component 250 are provided on the indicator assembly 200 for positioning the indicator 110 relative to the housing 120 instead of positioning aids 150-152. The compression spring 240 may cooperate with the slidable component 245 to facilitate positioning the indicator 110 in the open and closed positions, while the fixed component 250 serves to hold one end of the compression spring 240 to enable the compression spring 240 to be tensed and relaxed between the fixed component 250 and the slidable component 245. The slidable component may include a pin for supporting the compression spring 240 and the fixed component 250 may include a cylinder for receiving the compression spring 240 and pin therein. As shown in FIG. 15A, the slidable component 245 is tensed against a first portion 213 of the base 113 of the indicator 110 to maintain the indicator in the closed position. To raise the indicator 110, a cam 260 (FIG. 15C) coupled to the indicator 110 may be used to raise the indicator 110 towards its raised position, and during this movement, the indicator base 113 slides the slidable component 245 relative to the fixed component 250 against the force of the compression spring 240 as shown in FIG. 15B via a second portion 223 of the indicator base 113. The second portion 223 may include an angle or crest that requires the user to force the slidable component 245 against the force of the compression spring 240 until reaching the angle or crest, at which point the slidable component 245 overcomes the angle or crest of the second portion 223 and the compression spring 240 relaxes and begins to slide the slidable component 245 back towards the indicator base 113. As this occurs, the second portion 223 of the indicator base 113 and the slidable component 245 may thereby provide a tactile indication to the user that the indicator 110 is moving towards its raised position sufficiently to a point where the compression spring 240 will facilitate maintaining the indicator 110 in the raised position. Upon the indicator base 113 rotating sufficiently towards the raised position of the indicator 110, a third portion 233 of the indicator base moves past the slidable component 245 such that the compression spring 240 expands and relaxes and slides back towards the indicator base 113 to thereby rest against the third portion 233 to retain the indicator 110 in the raised position as shown in FIG. 15C. Other spring types and cam configurations that provide stabilization at specific angles to a rotating body, such as torsion springs may also be used.

Components of the indicator assembly 100 may be constructed of plastic, metal, composites, and so on. In some implementations, the housing 120 or another component may be configured to shield the indicator 110, for instance, where the indicator 110 or a portion thereof includes a detectable component such as transmitting or receiving an electronic signal, e.g., Wi-Fi signal, RFID signals, or illuminating an LED that can be sensed or detected only when the indicator 110 is exposed or raised from the housing 120. The housing 120 may block signals delivered or sensed from the indicator 110 when the indicator is retracted into the housing 120.

The indicator assembly 100 may be a device with non-electrical components, for instance, where the hinge mechanism 130 includes mechanical or magnetic positioning aids. In some implementations, where the hinge mechanism 130 and/or the switch mechanism 140 can be actuated electronically, the components may be battery operated, for instance, using a small battery such as a button battery, or the indicator assembly may be configured to be wired to and powered by a power source such as a USB drive or a power outlet. In some implementations, multiple visual indicators may be provided in the indicator assembly 100. In further implementations, the indicator assembly may be electronically actuable and, for instance, may be controlled using remote devices, such as via a Wi-Fi connection. Where the indicator assembly is wirelessly connected, a user device communicatively coupled to the indicator assembly may receive signals corresponding to a lowered and a raised position of the indicator. In yet further implementations, the indicator assembly may generate an audible signal to indicate when the indicator is raised or lowered. The audible signal may be generated through mechanical means, such as via cams moving past one another during raising and lowering movements, via a bell, or through electronic means, such as a signal generator actuated by the indicator upon it being lowering and/or raised.

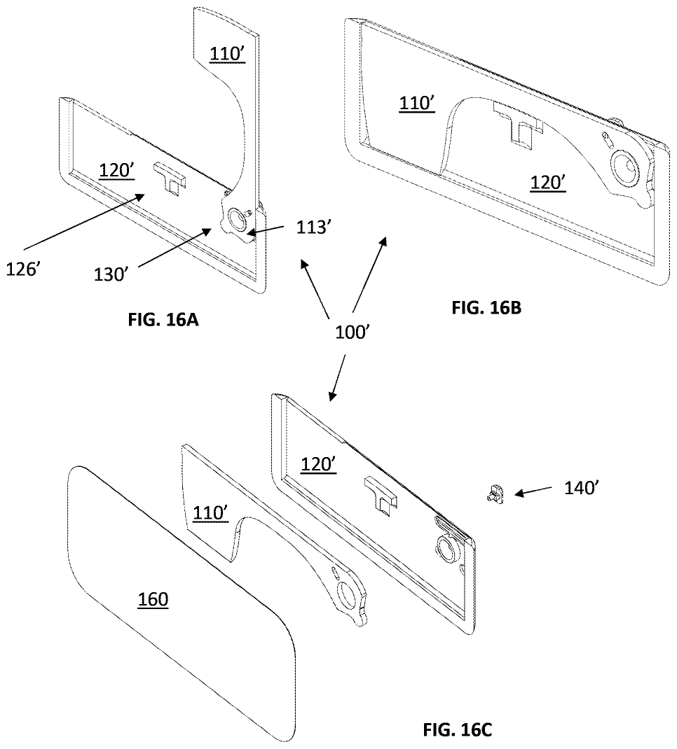

FIGS. 16A, 16B and 16C illustrate an another indicator assembly 100′ with slight modifications from the indicator assembly 100 disclosed herein. The indicator assembly 100′ includes an indicator 110′, a housing 120′, a hinge mechanism 130′, and a switch mechanism 140′. The indicator assembly 100′ includes slight cosmetic changes while functioning identically or substantially identically to the indicator assembly 100 disclosed herein. Cosmetic changes to the indicator assembly 100′ may include providing the indicator 110′ with an indicator base 113′ including a rounded protruding region, whereas the indicator base 113′ may include a squared-off region. The housing 120′ at the interior 126′ may include differently shaped structural features for supporting the indicator 110′ in the retracted position. A switch mechanism 140′ may be included a switch knob 141 with a rounded shape and/or may be integrally formed with the slider pin 142 (see FIGS. 8E, 8F, 8G and 8H).

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The preceding description of systems, methods, and apparatuses embody various elements of the present disclosure, and it should be understood that the described disclosure may be practiced in a variety of forms in addition to those described herein. More particularly, the foregoing description, for purposes of explanation, uses specific nomenclature to provide a thorough understanding of the described embodiments. It will be apparent to the skilled artisan that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Consequently, variations and modifications commensurate with the teachings, and skill and knowledge of the relevant art, are within the scope of the disclosure.

What is claimed is:

1. An indicator assembly, comprising:
an indicator;
a housing configured to receive the indicator in a lowered position of the indicator and configured to enable the indicator to extend from the housing in a raised position of the indicator;
a hinge mechanism configured to enable the indicator to rotate relative to the housing between the lowered position and the raised position; and
a switch mechanism comprising a switch assembly coupled to the indicator and the housing,
wherein the switch assembly is configured to move back and forth along a slider track of the housing such that the indicator moves from the lowered position to the raised position to thereby indicate a status of a user of the indicator assembly.

2. The indicator assembly of claim 1, wherein:
the indicator comprises a first positioning aid, and the housing comprises a second positioning aid and a third positioning aid,
wherein an arrangement of the first positioning aid relative to the second positioning aid defines the raised position in which the first positioning aid and the second positioning aid cooperate or facilitate maintaining the indicator in the raised position, and
an arrangement of the first positioning aid relative to the third positioning aid defines the lowered position in which the first positioning aid and the third positioning aid cooperate or facilitate maintaining the indicator in the lowered position.

3. The indicator assembly of claim 2, wherein the second positioning aid and the third positioning aid are arranged angularly offset relative to one another.

4. The indicator assembly of claim 3, wherein the angular offset is about 70 degrees to about 110 degrees.

5. The indicator assembly of claim 2, wherein the hinge mechanism is defined by the indicator and the housing, and wherein the first positioning aid, the second positioning aid and the third positioning aid are arranged proximate the hinge mechanism.

6. The indicator assembly of claim 5, wherein the indicator is configured as an arm and comprises an indicator shaft coupling the indicator head to an indicator base, and wherein the indicator base defines a portion of the hinge mechanism.

7. The indicator assembly of claim 2, wherein the first positioning aid is configured as a magnet and the second positioning aid and the third positioning aid are each configured as a magnet or a ferromagnetic material.

8. The indicator assembly of claim 2, wherein the first positioning aid is configured as a ferromagnetic material, and the second positioning aid and the third positioning aid are each configured as a magnet and angularly offset relative to one another.

9. The indicator assembly of claim 8, wherein the angular offset is about 70 degrees to about 110 degrees.

10. The indicator assembly of claim 2, wherein the switch assembly is configured to pivot the indicator between the lowered and raised position upon overcoming a force between the first positioning aid and either of the second positioning aid or the third positioning aid.

11. The indicator assembly of claim 1, wherein the indicator comprises an indicator head configured to be exposed from the housing in the raised position of the indicator, and wherein the indicator head comprises at least one of a rounded head or a sloped edge.

12. The indicator assembly of claim 1, wherein the indicator assembly is configured to couple to an object by an attachment feature.

13. The indicator assembly of claim 1, wherein the indicator assembly is configured to be integrated into an object such that the housing of the indicator assembly is defined by the object.

14. The indicator assembly of claim 13, wherein the object is a computer device.

15. The indicator assembly of claim 1, wherein:
the indicator comprises a first positioning aid configured as a magnet or ferromagnetic material, and the housing comprises a second positioning aid and a third positioning aid configured as the other of the magnet or ferromagnetic material,
an arrangement of the first positioning aid relative to the second positioning aid defines the raised position in which the magnet and ferromagnetic material are attracted to each other, and
an arrangement of the first positioning aid relative to the third positioning aid defines the lowered position in which the first positioning aid and the third positioning aid are attracted to each other.

16. The indicator assembly of claim 15, wherein the second positioning aid and the third positioning aid are arranged angularly offset relative to one another.

17. The indicator assembly of claim 16, wherein the angular offset is about 70 degrees to about 110 degrees.

18. The indicator assembly of claim 1, wherein:
the indicator comprises a first positioning aid configured as a magnet, and the housing comprises a second and a third positioning aid each configured as a magnet,
an arrangement of the first positioning aid relative to the second positioning aid defines the raised position in which the magnet of the first positioning aid and the magnet of the second positioning aid repel or attract each other, and
an arrangement of the first positioning aid relative to the third positioning aid defines the lowered position in which the first positioning aid and the third positioning aid repel or attract each other.

19. The indicator assembly of claim 18, wherein the second positioning aid and the third positioning aid are arranged angularly offset relative to one another.

20. The indicator assembly of claim 19, wherein the angular offset is about 70 degrees to about 110 degrees.
